(19) United States
(12) Patent Application Publication
(10) Pub. No.: US 2026/0311398 A1
(43) Pub. Date: Oct. 8, 2026

(54) METHOD AND SYSTEM FOR CONTENT GENERATION

(71) Applicant: ONIBER SOFTWARE PRIVATE LIMITED, Pune (IN)

(72) Inventors: Raghu Sesha Iyengar, Bangalore (IN); Abhijeet Zilpelwar, Pune (IN); Ankush Tiwari, Pune (IN)

(21) Appl. No.: 19/460,346

(22) Filed: Jan. 27, 2026

(30) Foreign Application Priority Data
Feb. 17, 2025 (IN) 202521013377

(51) Int. Cl. G06T 11/60; G06V 10/764; G06V 10/82; G06V 20/40

(52) U.S. Cl. CPC G06T 11/60; G06V 10/764; G06V 10/82; G06V 20/46

(57) ABSTRACT

The present invention relates to a method (300) and system (100) for generating content. The method (300) processes input data through a series of neural network models, including a feeder neural network and a pre-trained model, to enhance the features of the content. The system (100) adjusts the input content, which may be real or synthetic, optimizing its characteristics to improve realism. Using loss functions, the system (100) fine-tunes the content to ensure that the generated output closely resembles real media, reducing perceptible distortions. The process involves refining visual, auditory, or other media features to make the content indistinguishable from real-world examples. This approach supports various applications, such as synthetic media creation, digital content generation, and media enhancement. By leveraging this method, the system (100) produces high-quality content, providing an efficient framework for content generation tasks across industries like entertainment, media production, and content detection.

### CROSS-REFERENCE TO RELATED APPLICATIONS AND PRIORITY

The present application claims priority from Indian Patent Application No.: 202521013377 filed on Feb. 17, 2025.

### TECHNICAL FIELD

The presently disclosed embodiments are related, in general, to the field of media content generation. More specifically, the present disclosure focuses on techniques for generating synthetic media content, particularly in the context of improving the quality of generated content.

### BACKGROUND

This section is intended to introduce the reader to various aspects of the relevant technical field of media analysis and content classification systems, which are related to aspects of the present disclosure described or claimed below. This discussion is believed to be helpful in providing background information to facilitate a better understanding of the various aspects of the present disclosure. Accordingly, it should be understood that these statements in this background section are to be read in this light, and not as admissions of prior art. Similarly, a problem is mentioned in the background section.

The generation of synthetic media, including images, videos, and audio, has advanced significantly in recent years due to breakthroughs in machine learning techniques, particularly in the areas of deep neural networks and generative models. These advancements have enabled the creation of highly realistic synthetic content that is often indistinguishable from real-world media. Tools for generating such content are increasingly accessible, with many generative models being deployed through cloud-based platforms or open-source frameworks, making it possible for even non-experts to generate high-quality synthetic media. Consequently, the proliferation of synthetic media has raised concerns about its potential misuse, including the creation of deepfakes, misleading videos, and other forms of deceptive content.

As the quality and realism of synthetic media improve, so does the difficulty in distinguishing between real and fake content. Modern generative models, such as Generative Adversarial Networks (GANs), Variational Autoencoders (VAEs), and Diffusion models, have made it possible to create images and videos that replicate the subtle details of real human actions, speech, and expressions. This poses a significant challenge for detection systems, which are often unable to reliably identify synthetic content due to the increasingly sophisticated techniques used by generative models. As a result, the task of detecting fake media has become more complex, especially in fields such as security, media verification, and law enforcement, where distinguishing authentic media from falsified content is critical for maintaining trust and integrity.

While detecting whether media is real or synthetic is important, a more significant challenge lies in the ability to improve the detection models themselves in response to increasingly powerful generative techniques. As generative models grow more advanced, they can produce content that is specifically designed to fool detectors. In many cases, the existing detection models may struggle to provide meaningful feedback to improve the generator's performance, as they might fail to detect subtle differences in the content, resulting in inadequate training data for the generator. This creates an arms race between the detection models, which must continuously improve to stay ahead, and generative models, which must adapt to circumvent detection.

To address this issue, generative models have explored various strategies to enhance the quality of synthetic content. For instance, GANs use a dual-network approach involving a generator and a discriminator, where the generator creates content, and the discriminator attempts to classify it as either real or fake. While GANs have proven effective in generating high-quality images, their success heavily depends on the quality of the discriminator. If the discriminator is too powerful, as in the case of an advanced fake detection model, it can limit the generator's ability to improve, as the discriminator might prevent sufficient gradients from being passed to the generator.

Additionally, VAEs and diffusion models represent alternative generative approaches, but each comes with its own limitations. VAEs, while effective for generating general content, do not offer fine-grained control over the generated media, such as creating specific fakes of a known individual. Diffusion models, on the other hand, allow for conditioning the generation process on specific attributes, such as a particular person or object, but they operate through a computationally intensive denoising process. Despite these challenges, diffusion models have shown significant promise in creating high-quality synthetic images. However, they are still subject to the limitation of computational complexity, which may hinder their widespread use in real-time applications.

The problem of improving synthetic media generation while simultaneously enhancing detection techniques requires an innovative approach. Simply improving generative techniques or detection models independently is insufficient; both must evolve together to ensure that detection models remain effective against increasingly sophisticated fakes. In this context, a new methodology is needed to close the gap between the generative models and detection systems, enabling the generation of content that is challenging to distinguish from real media even for state-of-the-art detectors.

Therefore, there is a critical need for a system which effectively generates synthetic media utilizing detection models.

### SUMMARY

Before the present system and device and its components are summarized, it is to be understood that this disclosure is not limited to the system and its arrangement as described, as there can be multiple possible embodiments which are not expressly illustrated in the present disclosure. The present disclosure overcomes one or more shortcomings of the prior art and provides additional advantages discussed throughout the present disclosure. Additional features and advantages are realized through the techniques of the present disclosure. It is also to be understood that the terminology used in the description is for the purpose of describing the versions or embodiments only and is not intended to limit the scope of the present application.

This summary is provided to introduce concepts related to a method and a system for content generation. The detailed description further elaborates on these concepts, and this summary is not intended to identify essential features of the claimed subject matter, nor is it intended for use in determining or limiting the scope of the claimed subject matter.

According to embodiments illustrated in the present disclosure, the method involves receiving an input media file via a processor and preprocessing the received input media file. The pre-processed media file may then be used to generate embeddings through a pre-trained media transformer. These embeddings may be subsequently used to predict information corresponding to the embeddings of the received input media file, such as an indication of the embeddings of the received input media file to be either real or fake. A plurality of loss gradients may be calculated utilizing one or more loss functions based on the predicted information. Further, the backpropagation may be performed on the input media file using the loss gradients, to generate a new media file. The generated new media file may be then provided as an output.

In one embodiment, the generated embeddings are provided to a set of classification models, including a first and second classification model. Based on the generated embeddings, the first classification model may calculate a content classification score, indicating the probability of each chunk from the one or more chunks to be real or fake. Further based on the generated embeddings and the content classification score, the second classification model may calculate a content source classification score, determining the likelihood of each chunk from the one or more chunks belonging to a synthetic source from one or more synthetic sources. Further, the method may provide information regarding the input media file, including whether the media is real or fake.

The next step involves predicting information corresponding to the generated embeddings. This information may include an indication of whether the embeddings are associated with a real or fake media file. Afterwards, a plurality of loss gradients is calculated using one or more loss functions based on the predicted information. The method may then perform backpropagation on the input media file using the calculated loss gradients. This results in the generation of a new media file, which is ultimately provided as output. Through these steps, the method allows for content generation based on a series of transformations applied to the input media file.

The method described herein may utilize one or more loss functions, which may include a first loss function and a second loss function, which may correspond with loss functions such as cross-entropy and mean square error (MSE) models. These loss functions are applied to calculate the plurality of loss gradients corresponding to calculating a first loss gradient utilizing the first loss function and calculating a second loss gradient utilizing the second loss function. The first loss gradient may be calculated by providing a second input media file to the first loss function and the second loss gradient may be calculated by providing embeddings of the second input media file to the second loss function and the new media file may be consistent with the second input media file. The calculation of the plurality of loss gradients may be performed until the difference between the embeddings of the second input media file and embeddings of the received input media file is less than a predetermined threshold.

A system described herein for generating content may comprise a processor and a memory communicatively coupled to the processor. The memory may be configured to store one or more executable instructions that when executed by the processor, cause the processor to perform a series of operations. The processor may be configured to receive an input media file and preprocess the received input media file. After preprocessing, the processor may be configured to generate embeddings of the received input media file using a pre-trained media transformer. These embeddings may then be used to predict information corresponding to the embeddings of the received input media file, such as determining whether the embeddings represent a real or fake media file. The processor may be configured to calculate a plurality of loss gradients utilizing one or more loss functions based on the predicted information. Using these loss gradients, the processor may be configured to perform back-propagation to the received input media file, for generating a new media file. Finally, the processor may be configured to provide the new media file as output.

Additionally, the disclosure may include a non-transitory computer-readable storage medium having stored thereon a set of computer-executable instructions. When executed by a processor, these instructions may cause the processor to perform a series of steps. These steps may include receiving an input media file and preprocessing the received input media file. After preprocessing, the instructions may cause the processor to generate embeddings of the received input media file using a pre-trained media transformer. Further, the processor may predict information corresponding to the embeddings of the received input media file, where the information includes an indication of whether the embeddings are associated with a real or fake media file. The instructions may also cause the processor to calculate a plurality of loss gradients utilizing one or more loss functions based on the predicted information. Using the calculated loss gradients, the processor may perform back propagation on the received input media file to generate a new media file. Finally, the instructions may direct the processor to provide the new media file as output.

The foregoing summary is illustrative and not intended to limit the scope of the claimed subject matter. Further aspects, embodiments, and features will become apparent by reference to the detailed description and accompanying drawings.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements.

The detailed description is described with reference to the accompanying figures. In the figures, same numbers are used throughout the drawings to refer like features and components. Embodiments of a present disclosure will now be described, with reference to the following diagrams below wherein:

FIG. 1 is a block diagram that illustrates a system (100) for generating content in accordance with an embodiment of the present subject matter.

FIG. 2 is a block diagram that illustrates various components of an application server (101) configured for generating content, in accordance with an embodiment of the present subject matter.

FIG. 3 is a flowchart that illustrates a method (300) for generating content, in accordance with an embodiment of the present subject matter.

FIG. 4 illustrates a block diagram (400) of an exemplary computer system for implementing embodiments consistent with the present subject matter.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented, and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment. The terms “comprise”, “comprising”, “include(s)”, or any other variations thereof, are intended to cover a non-exclusive inclusion, such that a setup, system or method that comprises a list of components or steps does not include only those components or steps but may include other components or steps not expressly listed or inherent to such setup or system or method. In other words, one or more elements in a system or apparatus preceded by “comprises . . . a” does not, without more constraints, preclude the existence of other elements or additional elements in the system or apparatus.

An objective of the present disclosure is to provide a method and system that generates content.

Another objective of the present disclosure is to enable efficient preprocessing of input media files to facilitate content generation.

Yet another objective of the present disclosure is to use a pre-trained media transformer to generate embeddings of input media files for content generation.

Yet another objective of the present disclosure is to predict and classify media content as real or fake based on the generated embeddings.

Another objective of the present disclosure is to optimize content generation through the calculation of loss gradients and backpropagation techniques.

Yet another objective of the present disclosure is to enhance the accuracy and quality of generated content by utilizing advanced machine learning techniques, such as embeddings and loss gradient calculations.

Yet another objective of the present disclosure is to improve the efficiency and effectiveness of content generation through automated prediction and classification of media files as real or fake.

Yet another objective of the present disclosure is to allow users to customize and control the content generation process by providing input parameters or preferences for the media file transformations.

Yet another objective of the present disclosure is to enhance the scalability and flexibility of content generation by leveraging automated processing and prediction methods for various types of media files.

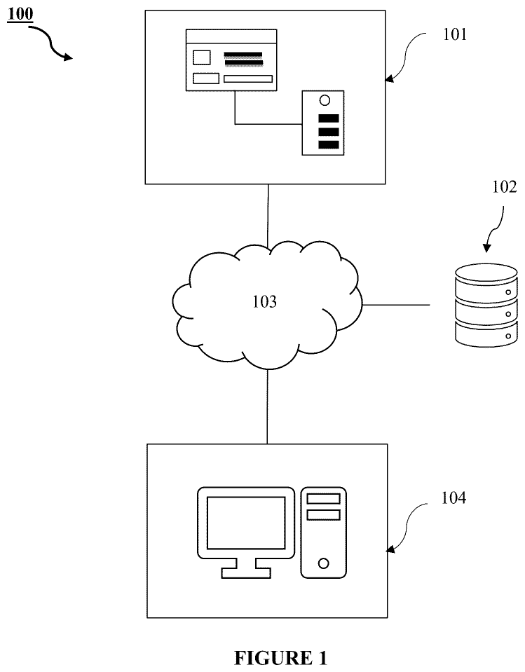

FIG. 1 is a block diagram that illustrates a system (100) for generating content, in accordance with an embodiment of present subject matter. The system (100) typically includes a database server (102), an application server (101), a communication network (103), and one or more portable devices (104). The database server (102), the application server (101), and the one or more portable devices (104) are typically communicatively coupled with each other via the communication network (103). In an embodiment, the application server (101) may communicate with the database server (102), and one or more portable devices (104) using one or more protocols such as, but not limited to, Hypertext Transfer Protocol (HTTP), Transmission Control Protocol/Internet Protocol (TCP/IP), Wireless Application Protocol (WAP), RF mesh, Bluetooth Low Energy (BLE), and the like, to communicate with one another.

In one embodiment, the database server (102) may refer to a computing device configured to store and manage data relevant to the generated content. This data may include user profiles, media sample repositories, speaker embeddings, pre-trained media transformer, content metadata, embedding data, loss gradients, and information regarding the predicted classification of media files, such as whether they are real or fake. The database server (102) may also store logs of content generation activities, user preferences, and system performance data to improve the content generation process. The database server (102) ensures that data is securely stored, readily accessible, and accurately updated to support real-time identification and adaptive processing within the system (100).

In an embodiment, the database server (102) may be a specialized operating system configured to perform one or more database operations on the stored content. Examples of database operations include but are not limited to, selecting, inserting, updating, and deleting media samples, embeddings, and user profiles. This specialized operating system optimizes the efficiency and accuracy of data management, ensuring that the system can quickly respond to real-time requests for generating content. In an embodiment, the database server (102) may include hardware that may be configured to perform one or more predetermined operations. In an embodiment, the database server (102) may be realized through various technologies such as, but not limited to, Microsoft® SQL Server, Oracle®, IBM DB2®, Microsoft Access®, PostgreSQL®, MySQL®, SQLite®, distributed database technology and the like. In an embodiment, the database server (102) may be configured to utilize the application server (101) for storage and retrieval of data used for generating content to generate a new media file and source of the input media file, this includes predicting whether the input media file is real or fake, and if fake, determining the likelihood of its origin from one or more synthetic sources based on the received input media file. Additionally, the database server (102) may calculate loss gradients using one or more loss functions based on the predicted information and perform backpropagation to the input media file using the calculated loss gradients to generate a new media file.

A person with ordinary skills in art will understand that the scope of the disclosure is not limited to the database server (102) as a separate entity. In an embodiment, the functionalities of the database server (102) can be integrated into the application server (101) or into the one or more portable device (104).

In an embodiment, the application server (101) may refer to a computing device or a software framework hosting an application, or a software service related to generating content. In an embodiment, the application server (101) may be implemented to execute procedures such as, but not limited to programs, routines, or scripts stored in one or more memory units to support the operation of the hosted application or software service. In an embodiment, the hosted application or the software service may be configured to perform one or more predetermined operations, including processing input media files, generating embeddings of the input media file, predicting information corresponding to the received input media file, calculating loss gradients based on predicted information, performing backpropagation for content refinement, and providing the new media file as output. The application server (101) may also be responsible for managing user interactions, tracking analysis progress, and presenting the classification results in a user-friendly manner on a user interface. The application server (101) may be realized through various types of application servers such as, but are not limited to, a Java application server, a .NET framework application server, a Base4 application server, a PHP framework application server, or any other application server framework.

In an embodiment, the application server (101) may be configured to utilize the database server (102) and the one or more portable device (104), in conjunction, with implementing the method for generating content. In an exemplary embodiment, the media processing environment may correspond to a content generation system. In an implementation, the application server (101) is configured for an automated processing of the input media file including both video and audio components in various formats, such as MP4, AVI, and MKV, to generate content and identify the source of the input media file.

In an embodiment, the application server (101) may serve as an infrastructure for executing the method which may include multiple stages of generating content. Each stage may involve specific steps such as receiving an input media file, preprocessing the received input media file, and generating embeddings of the received input media file using a pre-trained media transformer. Additionally, the application server (101) may predict information corresponding to the embeddings of the received input media file. Further, the application server (101) may calculate loss gradients utilizing one or more loss functions based on the predicted information. The application server (101) may then perform back propagation to the received input media file using the plurality of loss gradients, to generate a new media file. Finally, the system (100) may provide the new media file.

In yet another embodiment, the application server (101) may be configured to receive the input media file.

In yet another embodiment, the application server (101) may be configured to pre-process the received input media file.

In yet another embodiment, the application server (101) may be configured to generate embeddings of the received input media file after preprocessing, using a pre-trained media transformer.

In yet another embodiment, the application server (101) may be configured to predict an information corresponding to the embeddings of the received input media file which is indicative of the embeddings of the received input media file to be either real or fake.

In yet another embodiment, the application server (101) may be configured to calculate a plurality of loss gradients utilizing one or more loss functions based on the predicted information.

In yet another embodiment, the application server (101) may be configured to perform back propagation to the received input media file using the plurality of loss gradients, to generate a new media file.

In yet another embodiment, the application server (101) may be configured to provide the new media file.

In an embodiment, the communication network (103) may correspond to a communication medium through which the application server (101), the database server (102), and the one or more portable device (104) may communicate with each other. Such communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), Wireless Application Protocol (WAP), File Transfer Protocol (FTP), ZigBee, EDGE, infrared IR), IEEE 802.11, 802.16, 2G, 3G, 4G, 5G, 6G, 7G cellular communication protocols, and/or Bluetooth (BT) communication protocols. The communication network (103) may either be a dedicated network or a shared network. Further, the communication network (103) may include a variety of network devices, including routers, bridges, servers, computing devices, storage devices, and the like. The communication network (103) may include, but is not limited to, the Internet, intranet, a cloud network, a Wireless Fidelity (Wi-Fi) network, a Wireless Local Area Network (WLAN), a Local Area Network (LAN), a cable network, the wireless network, a telephone network (e.g., Analog, Digital, POTS, PSTN, ISDN, xDSL), a telephone line (POTS), a Metropolitan Area Network (MAN), an electronic positioning network, an X.25 network, an optical network (e.g., PON), a satellite network (e.g., VSAT), a packet-switched network, a circuit-switched network, a public network, a private network, and/or other wired or wireless communications network configured to carry data.

In an embodiment, the one or more portable devices (104) may refer to a computing device used by a user. The one or more portable devices (104) may comprise of one or more processors and one or more memory. The one or more memories may include computer readable code that may be executable by one or more processors to perform predetermined operations. In an embodiment, the one or more portable devices (104) may present a web user interface for user participation in the environment using the application server (101). Example web user interfaces presented on the one or more portable devices (104) to display the predicted information corresponding to the embeddings of the received input media file corresponding to an indication of the embeddings of the received input media file to be either real or fake. Examples of the one or more portable devices (104) may include, but are not limited to, a personal computer, a laptop, a computer desktop, a personal digital assistant (PDA), a mobile device, a tablet, or any other computing device.

The system (100) can be implemented using hardware, software, or a combination of both, which includes using where suitable, one or more computer programs, mobile applications, or “apps” by deploying either on-premises over the corresponding computing terminals or virtually over cloud infrastructure. The system (100) may include various micro-services or groups of independent computer programs which can act independently in collaboration with other micro-services. The system (100) may also interact with a third-party or external computer system. Internally, the system (100) may be the central processor of all requests for transactions by the various actors or users of the system. A critical attribute of the system (100) is that it may leverage the feeder neural network model, the pre-trained media transformer, the classification models and the loss functions to process various formats of media, including both audio and video files, for comprehensive generation of content. In a specific embodiment, the system (100) is implemented for generating content.

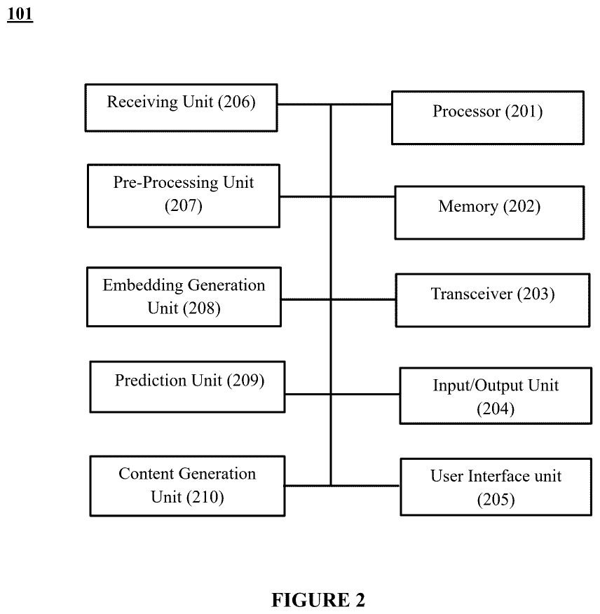

FIG. 2 illustrates a block diagram illustrating various components of the application server (101) configured for performing content generation based on input media files, in accordance with an embodiment of the present subject matter. Further, FIG. 2 is explained in conjunction with elements from FIG. 1. Here, the application server (101) preferably includes a processor (201), a memory (202), a transceiver (203), an Input/Output unit (204), a User Interface unit (205), a Receiving unit (206), a Pre-Processing unit (207), an Embedding Generation unit (208), a Prediction unit (209) and a Content Generation unit (210). The processor (201) is further preferably communicatively coupled to the memory (202), the transceiver (203), the Input/Output unit (204), the User Interface unit (205), the receiving unit (206), the pre-processing unit (207), the embeddings generation unit (208), the prediction unit (209), and the content generation unit (210) while the transceiver (203) is preferably communicatively coupled to the communication network (103).

In an embodiment, the application server (101) may be configured to receive the input media file. Further, the application server (101) may be configured to pre-process the received input media file. Further, the application server (101) may be configured to generate embeddings of the received input media file using a pre-trained media transformer. Further, predict an information corresponding to the embeddings of the received input media file, and the information may comprise an indication of the embeddings of the received input media file to be either real or fake. Furthermore, the application server (101) may calculate a plurality of loss gradients utilizing one or more loss functions based on the predicted information. Furthermore, perform back propagation to the received input media file using the plurality of loss gradients, to generate a new media file. Moreover, the application server (101) may be configured to provide the new media file.

The processor (201) comprises suitable logic, circuitry, interfaces, and/or code that may be configured to execute a set of instructions stored in the memory (202), and may be implemented based on several processor technologies known in the art. The processor (201) works in coordination with the transceiver (203), the Input/Output unit (204), the User Interface unit (205), the receiving unit (206), the pre-processing unit (207), the embeddings generation unit (208) the prediction unit (209), and the content generation unit (210) for generating content. Examples of the processor (201) include, but not limited to, standard microprocessor, microcontroller, central processing unit (CPU), an X86-based processor, a Reduced Instruction Set Computing (RISC) processor, an Application-Specific Integrated Circuit (ASIC) processor, and a Complex Instruction Set Computing (CISC) processor, distributed or cloud processing unit, state machines, logic circuitries, and/or any devices that manipulate signals based on operational instructions and/or other processing logic that accommodates the requirements of the present invention.

The memory (202) comprises suitable logic, circuitry, interfaces, and/or code that may be configured to store the set of instructions, which are executed by the processor (201). Preferably, the memory (202) is configured to store one or more programs, routines, or scripts that are executed in coordination with the processor (201). Additionally, the memory (202) may include any computer-readable medium or computer program product known in the art including, for example, volatile memory, such as static random-access memory (SRAM) and dynamic random-access memory (DRAM), and/or non-volatile memory, such as read only memory (ROM), erasable programmable ROM, a Hard Disk Drive (HDD), flash memories, Secure Digital (SD) card, Solid State Disks (SSD), optical disks, magnetic tapes, memory cards, virtual memory and distributed cloud storage. The memory (202) may be removable, non-removable, or a combination thereof. Further, the memory (202) may include routines, programs, objects, components, data structures, etc., which perform particular tasks or implement particular abstract data types. The memory (202) may include programs or coded instructions that supplement the applications and functions of the system (100). In one embodiment, the memory (202), amongst other things, may serve as a repository for storing data processed, received, and generated by one or more of the programs or coded instructions. In an exemplary embodiment, the stored data may include pre-processed input media files, generated embeddings, loss gradients, media features, content classification scores, content source classification scores, threshold and associated metadata. In yet another embodiment, the memory (202) may be managed under a federated structure that enables the adaptability and responsiveness of the application server (101).

The transceiver (203) comprises suitable logic, circuitry, interfaces, and/or code that may be configured to receive, process or transmit information, data or signals, which are stored by the memory (202) and executed by the processor (201). The transceiver (203) is preferably configured to receive, process or transmit, one or more programs, routines, or scripts that are executed in coordination with the processor (201). The transceiver (203) is preferably communicatively coupled to the communication network (103) of the system (100) for communicating all the information, data, signals, programs, routines or scripts through the network.

The transceiver (203) may implement one or more known technologies to support wired or wireless communication with the communication network (103). In an embodiment, the transceiver (203) may include but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. Also, the transceiver (203) may communicate via wireless communication with networks, such as the Internet, an Intranet and/or a wireless network, such as a cellular telephone network, a wireless local area network (LAN) and/or a metropolitan area network (MAN). Accordingly, the wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The input/output (I/O) unit (204) comprises suitable logic, circuitry, interfaces, and/or code that may be configured to receive or present information. The input/output unit (204) comprises various input and output devices that are configured to communicate with the processor (201). Examples of the input devices include, but are not limited to, a keyboard, a mouse, a joystick, a touch screen, a microphone, a camera, and/or a docking station. Examples of the output devices include, but are not limited to, a display screen and/or a speaker. The I/O unit (204) may include a variety of software and hardware interfaces, for example, a web interface, a graphical user interface, and the like. The I/O unit (204) may allow the system (100) to interact with the user directly or through the portable devices (104). Further, the I/O unit (204) may enable the system (100) to communicate with other computing devices, such as web servers and external data servers (not shown). The I/O unit (204) can facilitate multiple communications within a wide variety of networks and protocol types, including wired networks, for example, LAN, cable, etc., and wireless networks, such as WLAN, cellular, or satellite. The I/O unit (204) may include one or more ports for connecting a number of devices to one another or to another server. In one embodiment, the I/O unit (204) allows the application server (101) to be logically coupled to other portable devices (104), some of which may be built in. Illustrative components include tablets, mobile phones, desktop computers, wireless devices, etc.

In an embodiment, the input/output unit (204) may be configured to facilitate communication between the application server (101) and external devices, enabling seamless data transfer and user interaction. The input/output unit (204) may support various input devices, such as keyboards, touchpads, and trackpads, allowing users to provide input commands and navigate the user interface efficiently. Additionally, the input/output unit (204) may be configured to output the new media file through display devices, ensuring that users can easily interpret and utilize the information generated by the application server (101). Furthermore, the input/output unit (204) may incorporate connectivity options, such as USB, Bluetooth, or Wi-Fi, to enhance its capability to integrate with other systems and portable devices, thereby improving the overall user experience and functionality of the content analysis system.

Further, the user interface unit (205) may include the user interface (UI) designed to facilitate interaction with the system (100) for generating content. In an exemplary embodiment, the UI may allow users to upload the input media file for content generation. In an exemplary embodiment, users can interact with the UI through voice or text commands to initiate various operations, such as executing media generation tasks or adjusting parameters based on their preferences. In an exemplary embodiment, the UI may display the current status of the generated content process, and a classified portion of the input media file to the user. Additionally, the user interface (UI) of the system is designed to support multiple media formats, enabling user interaction with the input media file in the form of a video or audio. In an exemplary embodiment, the UI allows users to receive and preprocess the generation task of the video content in real time, ensuring that their specific needs are met. The UI may also display relevant information regarding the content generation process, including the pre-processing status, generation of embeddings, prediction corresponding to the embeddings, calculations of loss gradients, and generation of new media file.

In another embodiment, the receiving unit (206) of the application server (101), is disclosed. The receiving unit (206) is configured for receiving the input media file. In an exemplary embodiment, the receiving unit (206) may allow the system to receive input media files, including audio and video content, in various formats. For audio, the formats may include MP3, WAV, AAC, FLAC, OGG, WMA, and AIFF. For video, the formats may encompass MP4, AVI, MKV, MOV, WMV, FLV, and WEBM, or a combination thereof. The receiving unit (206) may verify the file format and size to ensure compatibility with the system's processing capabilities. Upon successful validation, the receiving unit (206) may transmit the media file to the processor (201) for further analysis.

In another embodiment, the pre-processing unit (207) of the application server (101), is disclosed. The pre-processing unit (207) may be configured to pre-process the received input media file. In an embodiment, the pre-processing unit (207) may be configured to pre-process the received input media file for sampling audio content of the received input media file based on a predefined sampling rate. In another embodiment, the pre-processing unit (207) may be configured sampling video data of the received input media file based on a predefined frame sampling rate. In another embodiment, the pre-processing unit (207) may be configured to filter the sampled input media file in the time domain to reduce either noise or artifacts in the frequency domain, thereby preparing the media file for further generation. In an exemplary embodiment, filtering of the sampled input media file may be performed using one of the hamming window, hanning window, low pass filter, high pass filter, band pass filter or a combination thereof.

In yet another embodiment, the pre-processing unit (207) may be configured to pre-process the received input media file to identify the one or more portions associated with one or more users, within the received input media file. The one or more portions may correspond to either voice information or facial information associated with the one or more users. The facial information associated with the one or more users may be identified using one of Multi-task Cascaded Convolutional Networks (MTCNN), Yoloface, deepFace, retinaFace, FaceNet, or a combination thereof.

Furthermore, the pre-processing unit (207) may be configured to split the pre-processed input media file into the one or more chunks. In one embodiment, splitting the pre-processed input media file into one or more chunks may be performed using a pre-defined time interval. In another embodiment, splitting of the video data of the received input media file into one or more chunks is performed either using the predefined time interval or a predefined number of frames. In a specific embodiment, the splitting of the video data of the received input media file may be performed by grouping the predefined number of frames for each face from the facial information associated with one or more faces of the one or more users. In an embodiment, each chunk from the one or more chunks corresponds to the plurality of frames associated with one or more portions with the one or more users. In an embodiment, the plurality of frames may be associated with either a facial image or a non-facial image. In an embodiment, each chunk from the one or more chunks, obtained by the splitting, may be partially overlapping with an adjacent chunk of the one or more chunks. In an embodiment, embeddings may be generated for each chunk from the one or more chunk of the received input media file.

In an exemplary embodiment, the receiving unit (206) may be configured to allow the user to select a specific chunk from the one or more chunks of the media, to determine the source of the one or more chunks.

Furthermore, the pre-processing unit (207) may be configured to extract one or more media features corresponding to each chunk from the one or more chunks obtained from the input media file. In an exemplary embodiment, the one or more media features may include one of pitch, background noise levels, spectral characteristics, temporal patterns, audio frequency ranges, file format, compression artifacts, channel separation, noise patterns, mel spectrogram, vocal tract model parameters, acoustic parameters, raw sample, frequency changes, a facial key points, swapped faces, cropped faces in RGB colour space, YUV colour space, masked faces, focussed eye region, lip region, facial expressions duration, number of pixels, number of person, video only, audio-video, frame rate, lighting inconsistencies, reflections, shadows, motion blur, noise patterns, or a combination thereof. These features contribute to the effective generation of the media content, facilitating accurate classification in subsequent processing steps.

In an embodiment, the pre-processing unit (207) may be configured to stack the extracted one or more media features, before passing to a feeder neural network model, to create a volume of input to the feeder neural network model. The feeder neural network model may correspond to one of the following models, but not limited to at least one of the convolutional neural network (CNN) layers, VGG (Visual Geometry Group), 3D-CNNs, fully connected layers, sigmoid activation, ReLU (Rectified Linear Unit) activation, dropout layers, ResNet (Residual Networks), RawNet2, LSTM (Long Short-Term Memory), Deep Neural Network (DNN), or a combination thereof.

Further, the embedding generation unit (208) may be configured for generating embeddings of each chunk from the one or more chunks, using a pre-trained media transformer based on the extracted one or more media features. In an embodiment, the embeddings generated by the embedding generation unit (208) may represent multi-dimensional vector representations of each chunk from the one or more chunks. Furthermore, the pre-embedding generation unit (208) may be configured to input the extracted one or more media features to the feeder neural network model based on the created volume of input, before passing to the pre-trained media transformer, for obtaining a changed activation volume of an input to the pre-trained media transformer. Further, the pre-trained media transformer may correspond to one of the following models, but not limited to, Audio Spectrogram Transformer model, Whisper model, Wav2Vec2, EnCodec, Hubert (Hidden-Unit BERT), VideoMAE, XClip, TimeSformer, ViViT, Vision Transformers (ViTs), BEiT (BERT Pre-Training of Image Transformers), CAiT (Class-Attention in Image Transformers), DeiT (Data-efficient Image Transformers), or a custom transformer-based neural network model designed for multi-modal media processing.

In an exemplary embodiment, embeddings may correspond to vector representations of the one or more media features. These embeddings may be multi-dimensional vector representations of each chunk, for example, represented as vectors with dimensions that may range from 512 to 2048. Specifically, for video processing, each input video chunk may be transformed into a vector of floating-point numbers, such as in case of VideoMAE transformer model, the encoder processes the input video chunks consisting of 16 frames to obtain a 768-dimensional vector representation.

In one embodiment, the pre-trained media transformer utilized by the system (100) is trained using a comprehensive dataset of audio and video samples specifically for the purpose of analyzing content authenticity. The embeddings generated by the pre-trained media transformer may be a multi-dimensional vector representation of each chunk from the one or more chunks. In an exemplary embodiment, in case of the pre-trained media transformer, the feeder neural network may generate an activation volume that aligns with the specific input dimensions expected by the pre-trained media transformer. For example, an output activation volume of a convolutional layer in a neural network could be 224×224×10, representing 10 channels with each channel having a height and a width of 224×224. The feeder neural network model is designed so that its output activation volume aligns with an input dimension required by the pre-trained media transformer namely VideoMAE, which may expect input in a specific format, such as 16×224×224×3. Here, 224×224×3 corresponds to an image with height and width of 224×224 and 3 channels (RGB), and the input consists of 16 such images stacked together. Thus, the embedding generation unit (208) ensures that the output activation volume of the feeder neural network model matches the input dimensions expected by the pre-trained media transformer, enabling seamless data flow and ensuring effective training of both models.

Furthermore, the embedding generation unit (208) may be configured to provide the generated embeddings to one or more classification models. The one or more classification models may comprise a first classification model and a second classification model. Furthermore, the embedding generation unit (208) may be configured to calculate a content classification score for each chunk from the one or more chunks, based on the generated embeddings. In an embodiment, the content classification score may indicate a probability of each chunk being classified as either a real chunk or a fake chunk, thereby facilitating the differentiation of synthetic source from one or more synthetic sources. Furthermore, the second classification model may utilize the synthetic content classification score and the generated embeddings, to compute a content source classification score, which reflects the likelihood of each chunk belonging to a synthetic source from one or more synthetic sources. This layered classification approach enhances the system's ability to accurately assess and differentiate between real and fake media content and their corresponding sources. In one embodiment, the one source from the one or more synthetic sources may be a real content source.

In an embodiment, the second classification model may be configured to compare the content source classification score of each chunk with a predefined threshold, enabling the classification of the chunk as belonging to the source from the one or more sources. In one embodiment, the first and second classification models may comprise a combination of fully connected linear layer neural networks and non-linear layer neural networks, enhancing their capacity for complex pattern recognition. Additionally, the second classification model may employ one or more techniques such as ReLU activation functions, Sigmoid activation functions, logistic regression, random forest algorithms, k-nearest neighbour (k-NN) methods, support vector machines (SVM), or a combination thereof, allowing for flexible and robust classification capabilities across varied data sets.

Furthermore, the prediction unit (209) may be configured to predict an information corresponding to the embeddings of the received input media file. In an embodiment, the information may comprise an indication of the embeddings of the received input media file to be either real or fake. In an embodiment, the prediction unit (209) may compare the received input media file embeddings with reference embeddings, generating a classification score that reflects the likelihood of the input being real or fake. This prediction may assist in further processing, enabling the system to make informed decisions regarding the authenticity of the media.

In an embodiment, the prediction unit (209) may calculate a plurality of loss gradients utilizing one or more loss functions based on the predicted information. In another embodiment, the one or more loss functions may comprise a first loss function and a second loss function. In another embodiment, the first loss function may correspond to a cross entropy loss function, and the second loss function may correspond to a mean square error (MSE) function. The one or more loss functions may include, but are not limited to, a cross-entropy loss model, a triplet loss model, an L2 regularizer, or a combination thereof, thereby enhancing the model's ability to minimize classification errors and improve overall accuracy.

In one embodiment, a content generation unit (210) is disclosed. The content generation unit (210) may generate a new media file by performing back propagation to the received input media file using the plurality of loss gradients. In another embodiment, calculating the plurality of loss gradients may correspond to calculating a first loss gradient utilizing the first loss function and calculating a second loss gradient utilizing the second loss function. In another embodiment, the first loss gradient may be calculated by providing a second input media file to the first loss function, and the second loss gradient may be calculated by providing embeddings of the second input media file to the second loss function, where the new media file may correspond to the second input media file.

In another embodiment, calculating the plurality of loss gradients is performed until the difference between the embeddings of the second input media file and embeddings of the received input media file is less than a predetermined threshold.

In another embodiment, generating embeddings of the new media file may correspond to a threshold. In another embodiment, the new media file embeddings may be generated until the threshold is met.

Further, the application server (101) may be configured to provide an information corresponding to the input media file. The information may comprise an indication of the input media file to be either real or fake and a source of the input media file. The source may be one of the one or more synthetic sources in case of the fake media or may be no source from the one or more synthetic sources in case of the real media.

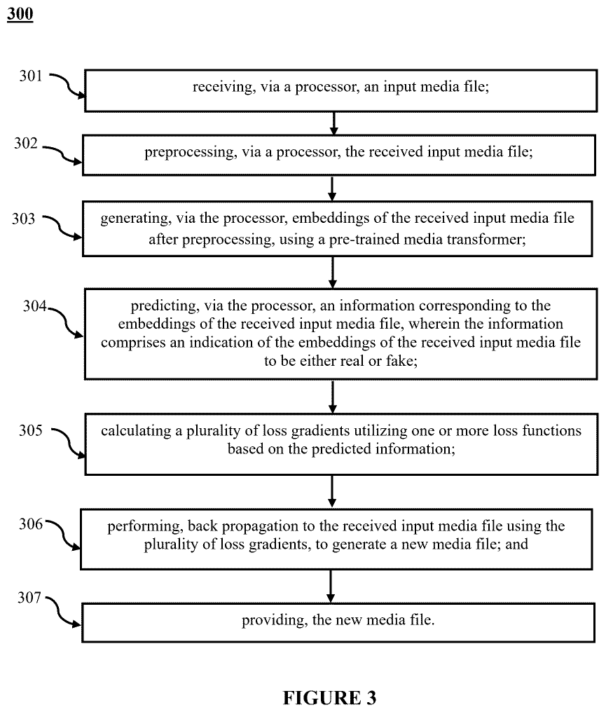

Referring to FIG. 3, a flowchart that illustrates a method (300) for generating content, in accordance with at least one embodiment of the present subject matter. The method (300) may be implemented by one or more portable devices (104) including the one or more processors (201) and the memory (202) communicatively coupled to the processor (201). The memory (202) is configured to store processor-executable programmed instructions, causing the processor (201) to perform the following steps:

At step (301), the processor (201) is configured to receive the input media file.

At step (302), the processor (201) is configured to pre-process the received input media file.

At step (303), the processor (201) is configured to generate embeddings of the received input media file after preprocessing, using a pre-trained media transformer.

At step (304), the processor (201) is configured to predict an information corresponding to the embeddings of the received input media file. In an embodiment, the information comprises an indication of the embeddings of the received input media file to be either real or fake.

At step (305), the processor (201) is configured to calculate a plurality of loss gradients utilizing one or more loss functions based on the predicted information.

At step (306), the processor (201) is configured to perform back propagation to the received input media file using the plurality of loss gradients, to generate a new media file.

At step (307), the processor (201) is configured to provide the new media file.

These sequence of steps may be repeated and continue till the system stops receiving the input media file.

Let us delve into a detailed example of the present disclosure.

### Example 1

Assume we have a trained transformer model that is capable of classifying whether a given video sample is real or fake. The model has been pre-trained on a large dataset containing both real and synthetic videos. We now wish to apply this model to improve the realism of a synthetic video containing the face of Person X.

Providing a synthetic video of Person X, generated using deepfake technology. The video is synthetic, and knowing that the model will likely classify it as fake upon initial evaluation. This serves as the starting point for the process.

The transformer model processes the synthetic video and predicts that it is fake. The model identifies certain features, such as unnatural lighting, slight inconsistencies in facial movements, or other artifacts commonly found in synthetic media.

To improve the synthetic video and make it more realistic, calculate two key loss components:

In this scenario, the true label of the video is set to REAL, even though the video is synthetic. The cross-entropy loss compares the model's prediction (fake) with the true label (real). This loss function penalizes any mismatch and encourages the model to adjust the features of the synthetic video to make it appear more like a real video.

Simultaneously, calculate the MSE loss, which measures the difference between the embeddings of the synthetic video and those of a real video featuring Person X. The MSE loss aims to minimize the difference between the facial features of the synthetic video and the real video, ensuring the adjustments made during the enhancement process reduce any noticeable differences.

Once the gradients are computed from both the CE and MSE losses, the model performs backpropagation to adjust the synthetic video's embeddings. This process fine-tunes the features of the video to make the synthetic video more similar to the real video, both in terms of visual features and facial embeddings.

The CE loss drives the synthetic video towards being classified as real. By encouraging the model to treat the synthetic content as real, this loss function effectively pushes the video's characteristics in the direction of realism.

The MSE loss refines the facial features, ensuring that the synthetic video's facial embeddings closely match those of the real video. The model ensures that the adjustments are subtle, preserving the integrity of the synthetic content while reducing perceptible artifacts that could give away its artificial nature.

### Example 2

Imagine a scenario where a synthetic video of Person Y, created using a GAN (Generative Adversarial Network), is initially classified by the fake detection model as fake. Let's walk through the steps of improving this video to make it harder for the model to detect:

A synthetic video of Person Y (e.g., from source S1) is provided to the trained transformer model. The model identifies the video as fake, since the GAN-generated face of Person Y doesn't quite match the natural facial features of a real person.

The true label for this synthetic video is REAL, and the model's prediction is fake. Using the cross-entropy loss, the model adjusts its weights to reduce the classification error, making the synthetic video appear more realistic, despite being generated from a GAN.

The MSE loss is calculated by comparing the embedding of the synthetic video with that of a real video of Person Y, recorded in a natural setting. The model adjusts the facial embeddings of the synthetic video to minimize the difference between the two, ensuring the synthetic video's facial features closely match the real person's face.

Once the loss gradients are computed from the CE and MSE loss, backpropagation is applied. This updates the synthetic video's embedding, subtly altering its features, so it now looks more similar to the real video of Person Y, making it harder for the model to classify it as fake.

The CE loss guides the model to reclassify the synthetic video as real, even though it is fake, by reducing visible distortions.

The MSE loss ensures the facial features of the synthetic video are adjusted to resemble those of the real Person Y video, reducing noticeable differences between the two. The result is a synthetic video that is very similar to a real one, but still classified as fake by the model due to slight imperfections that remain.

A person skilled in the art will understand that the scope of the disclosure is not limited to scenarios based on the aforementioned factors and using the aforementioned techniques, and that the examples provided do not limit the scope of the disclosure.

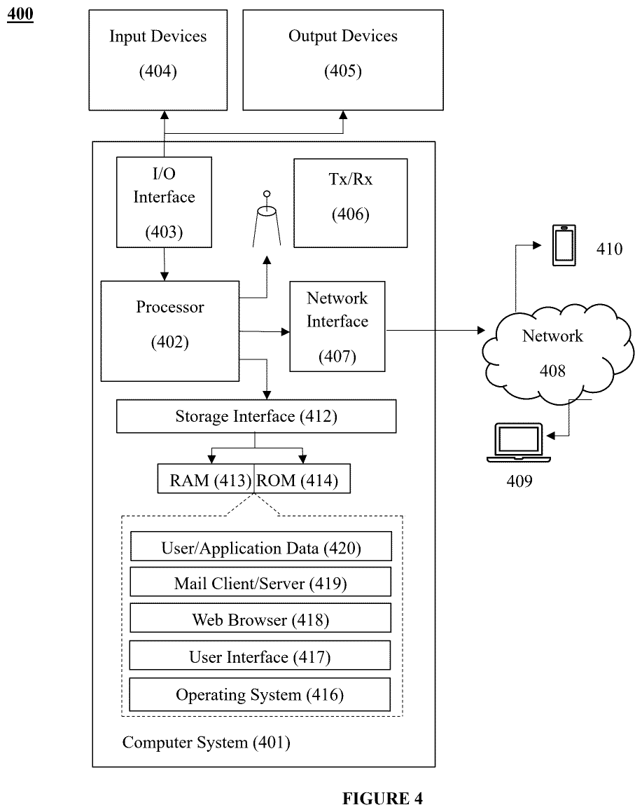

FIG. 4 illustrates a block diagram (400) of an exemplary computer system (401) for implementing embodiments consistent with the present disclosure.

Variations of a computer system (401) may be used for generating content. The computer system (401) may comprise a central processing unit (“CPU” or “processor”) (402). The processor (402) may comprise at least one data processor for executing program components for executing user or system generated requests. A user may include a person, a person using a device such as those included in this disclosure, or such a device itself. Additionally, the processor (402) may include specialized processing units such as integrated system (bus) controllers, memory management control units, floating point units, graphics processing units, digital signal processing units, or the like. In various implementations, the processor (402) may include a microprocessor, such as AMD Athlon, Duron or Opteron, ARM's application, embedded or secure processors, IBM PowerPC, Intel's Core, Itanium, Xeon, Celeron or other line of processors, for example. Accordingly, the processor (402) may be implemented using a mainframe, distributed processor, multi-core, parallel, grid, or other architectures. Some embodiments may utilize embedded technologies like application-specific integrated circuits (ASICs), digital signal processors (DSPs), or Field Programmable Gate Arrays (FPGAs), for example.

Processor (402) may be disposed of in communication with one or more input/output (I/O) devices via an I/O interface (403). Accordingly, the I/O interface (403) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like, for example.

Using the I/O interface (403), the computer system (401) may communicate with one or more I/O devices. For example, the input device (404) may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, or visors, for example. Likewise, an output device (405) may be a user's smartphone, tablet, cell phone, laptop, printer, computer desktop, fax machine, video display (e.g., cathode ray tube (CRT), liquid crystal display (LCD), light-emitting diode (LED), plasma, or the like), or audio speaker, for example. In some embodiments, a transceiver (406) may be disposed in connection with the processor (402). The transceiver (406) may facilitate various types of wireless transmission or reception. For example, the transceiver (406) may include an antenna operatively connected to a transceiver chip (example devices include the Texas Instruments® WiLink WL1283, Broadcom® BCM4750IUB8, Infineon Technologies® X-Gold 618-PMB9800, or the like), providing IEEE 802.11a/b/g/n, Bluetooth, FM, global positioning system (GPS), and/or 2G/3G/5G/6G HSDPA/HSUPA communications, for example.

In some embodiments, the processor (402) may be disposed in communication with a communication network (408) via a network interface (407). The network interface (407) is adapted to communicate with the communication network (408). The network interface (407) may employ connection protocols including, without limitation, direct connect, Ethernet (e.g., twisted pair 10/100/1000 Base T), transmission control protocol/internet protocol (TCP/IP), token ring, or IEEE 802.11a/b/g/n/x, for example. The communication network (408) may include, without limitation, a direct interconnection, local area network (LAN), wide area network (WAN), wireless network (e.g., using Wireless Application Protocol), or the Internet, for example. Using the network interface (407) and the communication network (408), the computer system (401) may communicate with devices such as shown as a laptop (409) or a mobile/cellular phone (410). Other exemplary devices may include, without limitation, personal computer(s), server(s), fax machines, printers, scanners, various mobile devices such as cellular telephones, smartphones (e.g., Apple iPhone, Blackberry, Android-based phones, etc.), tablet computers, desktop computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system (401) may itself embody one or more of these devices.

In some embodiments, the processor (402) may be disposed in communication with one or more memory devices (e.g., RAM 413, ROM 414, etc.) via a storage interface (412). The storage interface (412) may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, or solid-state drives, for example.

The memory devices may store a collection of program or database components, including, without limitation, an operating system (416), user interface application (417), web browser (418), mail client/server (419), user/application data (420) (e.g., any data variables or data records discussed in this disclosure) for example. The operating system (416) may facilitate resource management and operation of the computer system (401). Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

The user interface (417) is for facilitating the display, execution, interaction, manipulation, or operation of program components through textual or graphical facilities. For example, user interfaces (417) may provide computer interaction interface elements on a display system operatively connected to the computer system (401), such as cursors, icons, check boxes, menus, scrollers, windows, or widgets, for example. Graphical user interfaces (GUIs) may be employed, including, without limitation, Apple Macintosh operating systems'Aqua, IBM OS/2, Microsoft Windows (e.g., Aero, Metro, etc.), Unix X-Windows, or web interface libraries (e.g., ActiveX, Java, JavaScript, AJAX, HTML, Adobe Flash, etc.), for example.

In some embodiments, the computer system (401) may implement a web browser (418) stored program component. The web browser (418) may be a hypertext viewing application, such as Microsoft Internet Explorer, Google Chrome, Mozilla Firefox, Apple Safari, or Microsoft Edge, for example. Secure web browsing may be provided using HTTPS (secure hypertext transport protocol), secure sockets layer (SSL), Transport Layer Security (TLS), or the like. Web browsers may utilize facilities such as AJAX, DHTML, Adobe Flash, JavaScript, Java, or application programming interfaces (APIs), for example. In some embodiments the computer system (401) may implement a mail client/server (419) stored program component. The mail server (419) may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, or WebObjects, for example. The mail server (419) may utilize communication protocols such as internet message access protocol (IMAP), messaging application programming interface (MAPI), Microsoft Exchange, post office protocol (POP), simple mail transfer protocol (SMTP), or the like. In some embodiments, the computer system (401) may implement a mail client (420) stored program component. The mail client (420) may be a mail viewing application, such as Apple Mail, Microsoft Entourage, Microsoft Outlook, or Mozilla Thunderbird.

In some embodiments, the computer system (401) may store user/application data (421), such as the data, variables, records, or the like as described in this disclosure. Such databases may be implemented as fault-tolerant, relational, scalable, secure databases such as Oracle or Sybase, for example. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

Various embodiments of the disclosure encompass numerous advantages including methods and systems for generating content. The disclosed method and system have several technical advantages, but not limited to the following:
Improved Synthetic Content Quality: By utilizing feedback from a fake detection model during the generation process, the synthetic media becomes more sophisticated and realistic. This continuous refinement process allows for the creation of content that is increasingly difficult to distinguish from real-world media, enhancing its quality and authenticity.
Dynamic Adaptation to Detection Models: The use of loss gradients and backpropagation enables the generator to dynamically adapt to the strengths and weaknesses of the detection model. This mutual adaptation between the generator and detector ensures that the synthetic media produced is optimized to evade detection, even as detection models evolve and improve over time.
Creation of Enhanced Datasets for Detection Model Training: The generated synthetic media, which is specifically designed to deceive detection models, can be used as a dataset for training and improving fake detection systems. By including such “hard-to-detect” fake content in the training phase, detection models can become more robust, improving their accuracy in identifying subtle artifacts that are characteristic of synthetic media.
Reduced Need for Large Training Datasets: Traditional generative models often require large amounts of training data to produce high-quality content. By incorporating the fake detection model into the training process, the generator can improve the quality of the output more efficiently, potentially reducing the need for extensive datasets.
Real-time Media Verification: The integration of detection feedback into the generation process could enable real-time media verification applications. As detection models evolve and become more sophisticated, synthetic content can be generated that is tested against the latest detection systems, making it suitable for real-time deployment in fields such as law enforcement, media verification, and cybercrime prevention.
Adaptability to Various Media Types: The approach is not limited to any particular type of media (e.g., images, videos, audio). The method can be generalized across multiple media types, allowing for flexible application in a wide range of content generation tasks.

In summary, these technical advantages solve the technical problem of providing a reliable and efficient system for generating content, including the limitations in detecting increasingly sophisticated synthetic media. Traditional detection systems often struggle to identify subtle artifacts in highly realistic synthetic content, leading to reduced accuracy and reliability in media verification processes. By addressing these limitations, the present system provides an adaptive approach that not only improves the quality of generated synthetic media but also continuously enhances the effectiveness of fake detection models. This dynamic feedback loop allows both systems content generation and detection to evolve together, ensuring that the generated media becomes more convincing over time while detection models are strengthened to identify even the most challenging fakes. As a result, the present system offers a robust solution for improving the authenticity and trustworthiness of digital media content, particularly in high-stakes fields such as media forensics, security, and law enforcement.

The claimed invention of the system and the method for generating content, addresses the need for a more reliable and adaptive solution to generate and detect synthetic media. As the quality of synthetic content continues to improve, traditional detection methods struggle to keep up with increasingly sophisticated fakes. This invention provides a novel approach that not only enhances the generation of synthetic media to mimic real-world content more convincingly but also dynamically improves detection models by utilizing feedback from the detection system itself. By doing so, the invention ensures that both the generation and detection of synthetic content evolve together, addressing the growing challenge of maintaining media authenticity and trust in an era of advanced digital manipulation.

Furthermore, the invention involves a non-trivial combination of technologies and methodologies that provide a technical solution for a technical problem—specifically, the challenge of accurately generating content while minimizing false positives and false negatives. Traditional methods often struggle with the complexity and subtlety of manipulated content, leading to unreliable classifications that can compromise the integrity of media analysis. This invention leverages advanced machine learning algorithms, feature extraction techniques, and robust classification models to create a comprehensive framework capable of analyzing media content at a granular level. By integrating these technologies, the system effectively addresses the intricacies of synthetic media detection, ensuring a higher degree of precision in identifying authentic versus manipulated content. This not only enhances the reliability of content verification processes but also empowers users with actionable insights to combat misinformation in various applications.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments falling within the scope of the appended claims.

1. A method (300) for generating content, the method (300) comprises:
receiving (301), via a processor (201), an input media file;
preprocessing (302), via the processor (201), the received input media file;
generating (303), via the processor (201), embeddings of the received input media file after preprocessing, using a pre-trained media transformer;
predicting (304), via the processor (201), an information corresponding to the embeddings of the received input media file, wherein the information comprises an indication of the embeddings of the received input media file to be either real or fake;
calculating (305), via the processor (201), a plurality of loss gradients utilizing one or more loss functions based on the predicted information;
performing (306), via the processor (201), back propagation to the received input media file using the plurality of loss gradients, to generate a new media file; and
providing (307), via the processor (201), the new media file.

2. The method (300) as claimed in claim 1, wherein the input media file comprises one of an audio data, a video data or a combination thereof, wherein the preprocessing (302) the received input media file corresponds to sampling content of the audio data based on a predefined sampling rate, wherein preprocessing (302) the received input media file corresponds to sampling content of the video data based on a predefined frame sampling rate.

3. The method (300) as claimed in claim 2, comprises splitting the received input media file after preprocessing, into one or more chunks; wherein the splitting is performed using a pre-defined time interval, wherein splitting video data of the received input media file into one or more chunks is performed either using the predefined time interval or a predefined number of frames; wherein the splitting of the video data of the received input media file is performed by grouping the predefined number of frames for each face from facial information associated with one or more faces of one or more users; wherein each chunk from the one or more chunks, obtained by the splitting, is partially overlapping with an adjacent chunk of the one or more chunks; wherein embeddings are generated for each chunk from the one or more chunks of the received input media file.

4. The method (300) as claimed in claim 3, comprises extracting one or more media features corresponding to each chunk from the one or more chunks; wherein the one or more media features comprises one of a mel spectrogram, vocal tract model parameters, acoustic parameters, background noise, raw sample, pitch, frequency changes, a facial key points, swapped faces, cropped faces in RGB color space, YUV color space, masked faces, focussed eye region, lip region, facial expressions duration, number of pixels, number of person, video only, audio-video, file format, frame rate, compression artifacts, lighting inconsistencies, reflections, shadows, motion blur, noise patterns, or a combination thereof; wherein generating (303) of the embeddings is performed for each chunk from the one or more chunks based on the one or more media features.

5. The method (300) as claimed in claim 4, comprises stacking the extracted one or more media features, before passing to a feeder neural network model, to create a volume of input to the feeder neural network model; wherein the method (300) comprises providing the extracted one or more features to the feeder neural network model based on the created volume of input, before passing to the pre-trained media transformer for obtaining a changed activation volume of an input to the pre-trained media transformer.

6. The method (300) as claimed in claim 5, wherein the feeder neural network model corresponds to at least one of a convolutional neural network (CNN) layers, VGG (Visual Geometry Group), 3D-CNNs, fully connected layers, sigmoid activation, ReLU (Rectified Linear Unit) activation, dropout layers, ResNet (Residual Networks), RawNet2, LSTM (Long short-term memory), Deep Neural Network (DNN), or a combination thereof.

7. The method (300) as claimed in claim 2, wherein the embeddings generated by the pre-trained media transformer are multi-dimensional vector representation of each chunk from the one or more chunks, wherein the pre-trained media transformer corresponds to one of Audio Spectrogram Transformer model, Whisper model, Wav2Vec2, EnCodec, Hubert (Hidden-Unit BERT), VideoMAE, XClip, TimeSformer, ViViT, Vision Transformers (ViTs), BEiT (BERT Pre-Training of Image Transformers), CAiT (Class-Attention in Image Transformers), DeiT (Data-efficient Image Transformers) or a combination thereof.

8. The method (300) as claimed in claim 1, comprises providing the generated embeddings to one or more classification models, wherein the one or more classification models comprises a first classification model and a second classification model.

9. The method (300) as claimed in claim 8, comprises calculating a content classification score, using the first classification model based on the generated embeddings, wherein the content classification score is indicative of probability of the each chunk from the one or more chunks to be either real or fake.

10. The method (300) as claimed in claim 9, comprises calculating a content source classification score, using the second classification model based on the generated embeddings and the content classification score, wherein the content source classification score is indicative of probability of the each chunk from the one or more chunks belongs to a synthetic source from one or more synthetic sources.

11. The method (300) as claimed in claim 10, wherein the second classification model is configured to compare the content source classification score, of each chunk, with a predefined threshold to classify the chunk belongs to the source from the one or more sources; wherein the first classification model and the second classification model comprise a combination of fully connected linear layer neural network and non-linear layer neural network, wherein the second classification model corresponds to one of a ReLU activation function, a Sigmoid activation function, logistic regression, random forest, k-nearest neighbour (k-NN), support vector machines (SVM), or a combination thereof.

12. The method (300) as claimed in claim 1, wherein the method (300) comprises filtering the sampled input media file in time domain to reduce either noise or artifacts in the frequency domain, wherein filtering of the sampled input media file is performed using one of hamming window, hanning window, low pass filter, high pass filter, band pass filter or a combination thereof; wherein the method (300) comprises preprocessing the input media file for identifying one or more portions associated with one or more users, within the received input media file, wherein the one or more portions corresponds to either voice information or facial information, associated with the one or more users, wherein the facial information associated with the one or more users are identified by using one of Multi-task Cascaded Convolutional Networks (MTCNN), Yoloface, deepFace, retinaFace, FaceNet or a combination thereof.

13. The method (300) as claimed in claim 1, comprises generating embeddings of the new media file, wherein the embeddings of the new media file correspond to a threshold, wherein the new media file embeddings will be generated until the threshold is met.

14. The method (300) as claimed in claim 1, wherein the one or more loss functions comprises a first loss function and a second loss function, wherein the first loss function corresponds to cross entropy loss function and the second loss function corresponds to a mean square error (MSE) function.

15. The method (300) as claimed in claim 14, wherein calculating the plurality of loss gradients corresponds to calculating a first loss gradient utilizing the first loss function and calculating a second loss gradient utilizing the second loss function, wherein the first loss gradient is calculated by providing a second input media file to the first loss function, wherein the second loss gradient is calculated by providing embeddings of the second input media file to the second loss function, wherein the new media file corresponds to the second input media file.

16. The method (300) as claimed in claim 15, wherein calculating the plurality of loss gradients is performed until the difference between the embeddings of the second input media file and embeddings of the received input media file is less than a predetermined threshold.

17. A system (100) for generating content, the system (100) comprises:
a processor (201);
a memory (202) communicatively coupled to the processor (201), wherein the memory (202) is configured to store one or more executable instructions that when executed by the processor (201), cause the processor (201) to:
receive (301) an input media file;
preprocess (302) the received input media file;
generate (303) embeddings of the received input media file after preprocessing, using a pre-trained media transformer;
predict (304) an information corresponding to the embeddings of the received input media file, wherein the information comprises an indication of the embeddings of the received input media file to be either real or fake;
calculate (305) a plurality of loss gradients utilizing one or more loss functions based on the predicted information;
perform (306) back propagation to the received input media file using the plurality of loss gradients, to generate a new media file; and
provide (307) the new media file.

18. A non-transitory computer-readable storage medium having stored thereon a set of computer-executable instructions that, when executed by a processor (201), cause the processor (201) to perform steps comprising:
receive (301) an input media file;
preprocess (302) the received input media file;
generate (303) embeddings of the received input media file after preprocessing, using a pre-trained media transformer;
predict (304) an information corresponding to the embeddings of the received input media file, wherein the information comprises an indication of the embeddings of the received input media file to be either real or fake;
calculate (305) a plurality of loss gradients utilizing one or more loss functions based on the predicted information;
perform (306) back propagation to the received input media file using the plurality of loss gradients, to generate a new media file; and
provide (307) the new media file.
